(19) United States
(12) Patent Application Publication
(10) Pub. No.: US 2024/0162560 A1
(43) Pub. Date: May 16, 2024

(54) STORAGE SYSTEM CONFIGURED FOR USE WITH AN ENERGY MANAGEMENT SYSTEM

(71) Applicant: Enphase Energy, Inc., Petaluma, CA (US)

(72) Inventor: Vikram Nandakumar IYENGAR, Austin, TX (US)

(21) Appl. No.: 18/388,948

(22) Filed: Nov. 13, 2023

Related U.S. Application Data
(60) Provisional application No. 63/425,589, filed on Nov. 15, 2022.

(51) Int. Cl. H01M 50/383; H01M 10/48; H01M 50/119; H01M 50/682

(52) U.S. Cl. CPC H01M 50/383; H01M 10/486; H01M 50/119; H01M 50/682

(57) ABSTRACT

A storage system configured for use with an energy management system is provided and includes an enclosure configured to house a battery, a thermal device disposed within the enclosure and configured to detect when a predetermined temperature is reached within the enclosure, a nozzle connected to a cartridge comprising fire retardant material and to the thermal device, wherein the nozzle is disposed on the enclosure to direct the fire retardant material into the enclosure when the thermal device detects the predetermined temperature is reached within the enclosure.

### CROSS-REFERENCE TO RELATED APPLICATIONS

The present application claims the benefit of and priority to U.S. Provisional Application Ser. No. 63/425,589, filed on Nov. 15, 2022, the entire contents of which is incorporated herein by reference.

### BACKGROUND

### Field of the Disclosure

Embodiments of the present disclosure generally relate to power systems and, for example, to methods and apparatus configured to reduce impact of thermal runaway in a storage system.

### Description of the Related Art

Storage systems configured for use with energy management systems are known. Typically, the storage systems comprise one or more batteries that are configured for single-phase operation or three-phase operation. The one or more batteries comprise one or more cells. During operation, an uncontrollable thermal event, e.g., thermal runaway, can be caused when one of the cells (an initiating cell) reaches relatively high temperature. During thermal runaway, a chemical reaction can sometimes occur in the initiating cell. For example, the heat generated by an initiating cell can diffusively propagate to one or more adjacent cells, thus causing the one or more adjacent cells to enter the same thermal runaway state. Such propagation can lead to excessive (unwanted) energy being released by the one or more adjacent cells in thermal runaway state. Additionally, thermal runaway events can cause large fires that could lead to serious damage to property and personal, and even after the fire has been externally extinguished (e.g., visually) chances of autoignition still exist.

Therefore, the inventors have provided herein improved storage systems configured to reduce impact of thermal runaway in a storage system.

### SUMMARY

In accordance with some aspects of the present disclosure, a storage system configured for use with an energy management system comprises an enclosure configured to house a battery, a thermal device disposed within the enclosure and configured to detect when a predetermined temperature is reached within the enclosure, a nozzle connected to a cartridge comprising fire retardant material and to the thermal device, wherein the nozzle is disposed on the enclosure to direct the fire retardant material into the enclosure when the thermal device detects the predetermined temperature is reached within the enclosure.

In accordance with some aspects of the present disclosure, an energy management system comprises a power source and storage system connected to the power source comprising an enclosure configured to house a battery, a thermal device disposed within the enclosure and configured to detect when a predetermined temperature is reached within the enclosure, a nozzle connected to a cartridge comprising fire retardant material and to the thermal device, wherein the nozzle is disposed on the enclosure to direct the fire retardant material into the enclosure when the thermal device detects the predetermined temperature is reached within the enclosure.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure; and

FIG. 3 is a block diagram of a battery, in accordance with at least some embodiments of the present disclosure.

### DETAILED DESCRIPTION

In accordance with the present disclosure, methods and apparatus configured to reduce impact of thermal runaway in a storage system are provided herein. For example, a storage system can be configured for use with an energy management system and comprises an enclosure configured to house a battery. A thermal device can be disposed within the housing and configured to detect when a predetermined temperature is reached within the enclosure. A nozzle can be connected to a cartridge comprising fire retardant material and to the thermal device. Additionally, the nozzle can be disposed on the enclosure to direct the fire retardant material into the enclosure when the thermal device detects the predetermined temperature is reached within the enclosure. The methods and apparatus described herein provide one or more fire retardants to serve as a first line of protection from large scale effects of thermal propagation, e.g., a thermal runaway event, such as battery fires and is capable of curbing the battery fire and spread thereof within seconds of detecting the thermal runaway event.

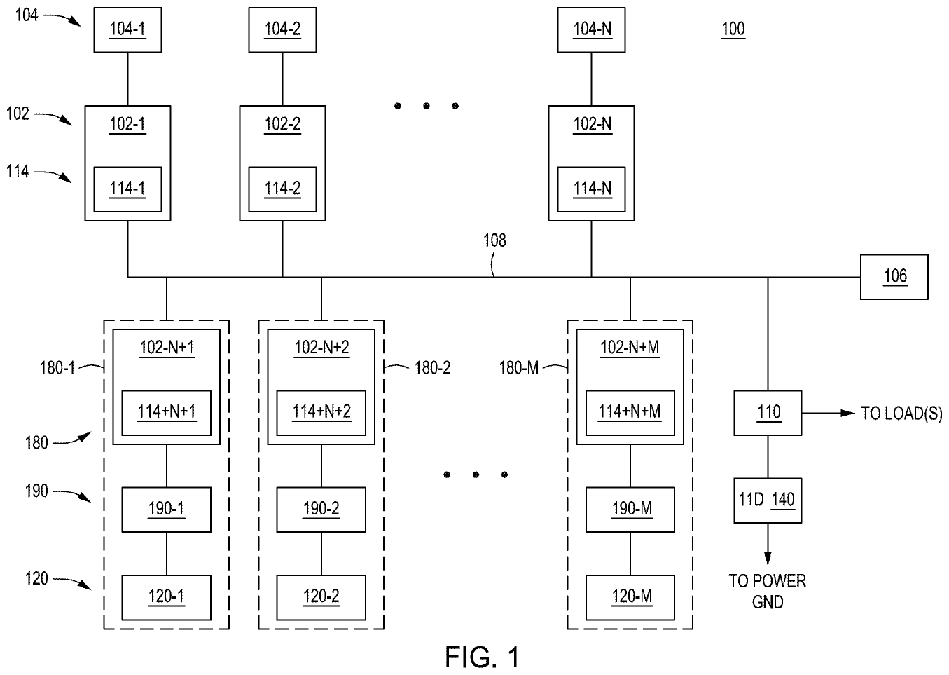

FIG. 1 is a block diagram of a system 100 (energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners); a plurality of DC power sources 104-1, 104-2, . . . 104-N, collectively referred to as power sources 104 (e.g., resources); a plurality of energy storage devices/delivery devices 120-1, 120-2, . . . 120-M collectively referred to as energy storage/delivery devices 120; a system controller 106; a plurality of BMUs 190-1, 190-2, . . . 190-M (battery management units) collectively referred to as BMUs 190; a system controller 106; a bus 108; a load center 110; and an IID 140 (island interconnect device) (which may also be referred to as a microgrid interconnect device (MID)). In some embodiments, such as the embodiments described herein, the energy storage/delivery devices are rechargeable batteries (e.g., multi-C-rate collection of AC batteries) which may be referred to as batteries 120, although in other embodiments the energy storage/delivery devices may be any other suitable device for storing energy and providing the stored energy. Generally, each of the batteries 120 comprises a plurality cells that are coupled in series, e.g., eight cells coupled in series to form a battery 120.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to plurality of energy storage devices/delivery devices 120-1, 120-2 . . . 120-M via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108, and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharging batteries 120 to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

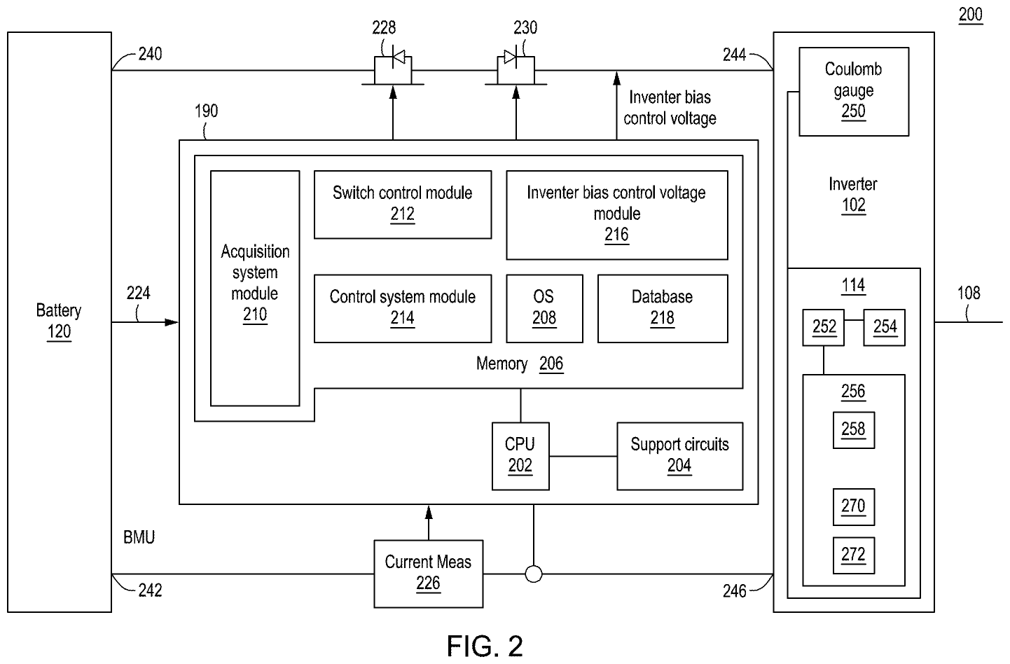

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 190 coupled to a battery (e.g., the battery 120) and one or more inverters (e.g., the power converters 102). In at least some embodiments, the battery 120 can comprise a plurality of cells (not shown) and the power converters 102 can comprise four embedded converters (e.g., four embedded microinverters). In at least some embodiments, the battery 120 can be the IQ Battery 3 (or the IQ Battery 10) and the microinverters can be the IQ8X-BAT microinverters, both available from Enphase®. A pair of metal-oxide-semiconductor field-effect transistors (MOSFETs) switches—switches 228 and 230—are coupled in series between a first terminal 240 of the battery 120 and a first terminal of the inverter 144 such the body diode cathode terminal of the switch 228 is coupled to the first terminal 240 of the battery 120 and the body diode cathode terminal of the switch 230 is coupled to the first terminal 244 of the power converter 102. The gate terminals of the switches 228 and 230 are coupled to the BMU 190.

A second terminal 242 of the battery 120 is coupled to a second terminal 246 of the power converter 102 via a current measurement module 226 which measures the current flowing between the battery 120 and the power converter 102.

The BMU 190 is coupled to the current measurement module 226 for receiving information on the measured current, and also receives an input 224 from the battery 120 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 120 to the power converter 102 through the body diode of the switch 230. When the switch 228 is inactive while the switch 230 is active, battery charge is enabled to allow current flow from the power converter 102 to the battery 120 through the body diode of the switch 228. When both switches 228 and 230 are active, the system is in a normal mode where the battery 120 can be charged or discharged.

The BMU 190 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 120 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SoC) analysis (e.g., coulomb gauge 250 for determining current flow and utilizing the current flow in estimating the battery SoC; synchronizing estimated SOC values to battery voltages (such as setting SoC to an upper bound, such as 100%, at maximum battery voltage; setting SoC to a lower bound, such as 0%, at a minimum battery voltage); turning off SoC if the power converter 102 never drives the battery 120 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SoC bounds based on battery end of charge and end of discharge, respectively, and tracking the current flow and cell voltage (i.e., battery voltage) between these events, the BMU 190 determines the estimated SoC.

Continuing with reference to FIG. 2, the inverter controller 114 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the batteries 120 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below.

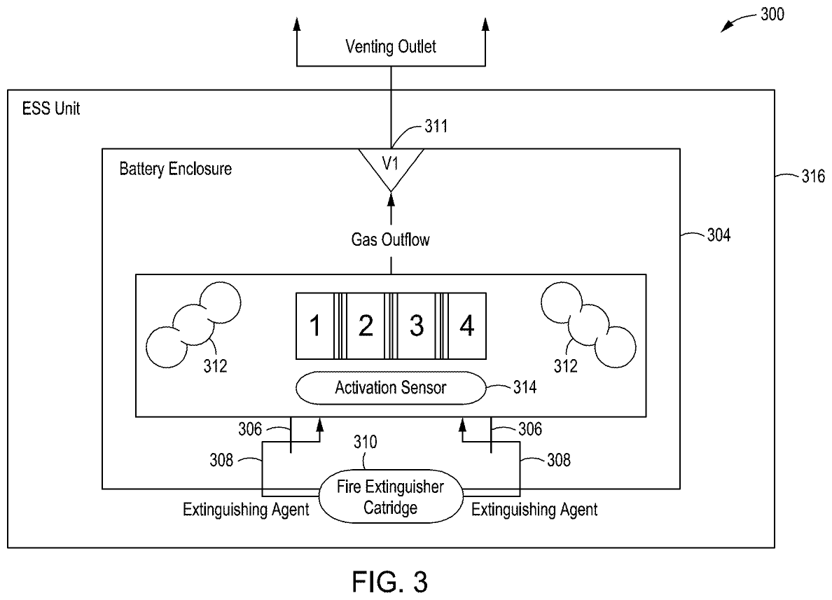

FIG. 3 is a block diagram of a battery 300 (e.g., the battery 120), in accordance with at least some embodiments of the present disclosure. The battery 300 has a plurality of cells 302 (four cells shown) and is housed within an enclosure 304, which can be made of one or more suitable materials. In at least some embodiments, the enclosure 304 can be made from metal or a metal alloy.

One or more thermal devices 306 are disposed within the enclosure 304 and configured to detect when a predetermined temperature is reached within the enclosure 304. The one or more thermal devices 306 can be at least one of a thermocouple, a thermostat, a thermistor, or a bimetallic strip. In at least some embodiments, the one or more thermal device 306 is a bimetallic strip.

One or more nozzles 308 are operably connected (pipping, tubing, etc.) to a cartridge 310 comprising fire retardant material 312 (e.g., made from at least one of silicone foam, polyurethane expanding foam, or class B foam) and to the one or more thermal devices 306. For example, the one or more thermal devices 306 can be a bimetallic strip switch disposed within or adjacent to (e.g., within the piping) the one or more nozzles 308 such that the bimetallic strip switch triggers a release of the fire retardant material 312 under high thermal event. For example, the one or more nozzles 308 including the one or more thermal devices 306 can be positioned along/secured to one or more interior walls of the enclosure 304 to direct the fire retardant material 312 into the enclosure 304 when the one or more thermal devices 306 detect that the predetermined temperature is reached within the enclosure 304. In at least some embodiments, each nozzle of the one or more nozzles 308 can connected to a corresponding cartridge. Alternatively, a single cartridge can be connected to each of the one or more nozzles 308 for providing the fire retardant material 312 into the enclosure 304 (as illustrated in FIG. 3). The cartridge(s) is/are removably coupled to the enclosure 304 for at least one of refilling or replacing.

In at least some embodiments, a venting outlet 311 (e.g., for gas outflow) can be disposed on the enclosure 304 and be configured to release one or more gases that can be present within the enclosure 304 due to the discharge of the fire retardant material 312.

In at least some embodiments, one or more temperature sensors 314 are configured to detect when the predetermined temperature is reached within the enclosure 304. The one or more temperature sensors 314 are operably coupled to at least one of the cartridge 310, the one or more thermal devices 306 and/or the one or more nozzles 308 for confirming that the predetermined temperature is reached within the enclosure 304. In at least some embodiments, the one or more temperature sensors 314 can be operably connected to the or more thermal devices 306 such that discharge of the fire retardant material is controlled by the one or more temperature sensors 314.

In at least some embodiments, an optional protective jacket 316 surrounds the enclosure 304 and comprises a recording device 318 configured to record data within the enclosure 304 prior to, during, and after the predetermined temperature is reached within the enclosure, e.g., to help refine future designs of the battery 120 and/or components thereof.

While the foregoing is directed to embodiments of the present disclosure, other and further embodiments of the disclosure may be devised without departing from the basic scope thereof, and the scope thereof is determined by the claims that follow.

1. A storage system configured for use with an energy management system, comprising:
an enclosure configured to house a battery;
a thermal device disposed within the enclosure and configured to detect when a predetermined temperature is reached within the enclosure; and
a nozzle connected to a cartridge comprising fire retardant material and to the thermal device, wherein the nozzle is disposed on the enclosure to direct the fire retardant material into the enclosure when the thermal device detects the predetermined temperature is reached within the enclosure.

2. The storage system of claim 1, wherein the thermal device is at least one of a thermocouple, a thermostat, a thermistor, or a bimetallic strip.

3. The storage system of claim 1, wherein the fire retardant material is at least one of silicone foam or polyurethane expanding foam.

4. The storage system of claim 1, wherein the fire retardant material is made from class B foam.

5. The storage system of claim 1, further comprising a temperature sensor that is configured to detect when the predetermined temperature is reached within the enclosure.

6. The storage system of claim 5, wherein the temperature sensor is operably coupled to at least one of the cartridge, the thermal device, or the nozzle for confirming that the predetermined temperature is reached within the enclosure, and wherein discharge of the fire retardant material is controlled by the temperature sensor.

7. The storage system of claim 1, wherein the enclosure is made from metal.

8. The storage system of claim 1, wherein the cartridge is removably coupled to the enclosure for at least one of refilling or replacing.

9. The storage system of claim 1, further comprising a protective jacket that surrounds the enclosure and comprises a recording device configured to record data within the enclosure prior to, during, and after the predetermined temperature is reached within the enclosure.

10. An energy management system, comprising:
a power source; and
a storage system connected to the power source comprising:
an enclosure configured to house a battery;
a thermal device disposed within the enclosure and configured to detect when a predetermined temperature is reached within the enclosure; and
a nozzle connected to a cartridge comprising fire retardant material and to the thermal device, wherein the nozzle is disposed on the enclosure to direct the fire retardant material into the enclosure when the thermal device detects the predetermined temperature is reached within the enclosure.

11. The energy management system of claim 10, wherein the thermal device is at least one of a thermocouple, a thermostat, a thermistor, or a bimetallic strip.

12. The energy management system of claim 10, wherein the fire retardant material is at least one of silicone foam or polyurethane expanding foam.

13. The energy management system of claim 10, wherein the fire retardant material is made from class B foam.

14. The energy management system of claim 10, further comprising a temperature sensor that is configured to detect when the predetermined temperature is reached within the enclosure.

15. The energy management system of claim 14, wherein the temperature sensor is operably coupled to at least one of the cartridge, the thermal device, or the nozzle for confirming that the predetermined temperature is reached within the enclosure, and wherein discharge of the fire retardant material is controlled by the temperature sensor.

16. The energy management system of claim 10, wherein the cartridge is removably coupled to the enclosure for at least one of refilling or replacing.

17. The energy management system of claim 10, further comprising a protective jacket that surrounds the enclosure and comprises a recording device configured to record data within the enclosure prior to, during, and after the predetermined temperature is reached within the enclosure.
